(19) United States
(12) Patent Application Publication
(10) Pub. No.: US 2024/0117221 A1
(43) Pub. Date: Apr. 11, 2024

(54) METHODS OF BONDING METAL ARTICLES AND ARTICLES FORMED THEREBY

(71) Applicant: 3M INNOVATIVE PROPERTIES COMPANY, St. Paul, MN (US)

(72) Inventors: Matthew J. Kryger, Hudson, WI (US); Chase M. O'Brien, Roseville, MN (US); Dennis C. Ngo, Woodbury, MN (US); Eric R. Amann, St. Paul, MN (US)

(21) Appl. No.: 18/257,312

(22) PCT Filed: Dec. 15, 2021
(86) PCT No.: PCT/IB2021/061794

§ 371 Date: Jun. 14, 2023

Related U.S. Application Data
(60) Provisional application No. 63/127,432, filed on Dec. 18, 2020.

(51) Int. Cl. C09J 5/00; C09J 11/04; C09J 163/00

(52) U.S. Cl. CPC C09J 5/00; C09J 11/04; C09J 163/00; C09J 2463/00

(57) ABSTRACT

Methods of bonding a male element and a female element, the method including applying an adhesive composition to at least the male element, the male element including a first metal; inserting at least a portion of the male element into the female element thereby forming an external interface between the male element and the female element, the female element including a second metal; and curing the adhesive composition to form an adhesive bond between the male element and the female element, wherein the first metal and the second metal are not the same, wherein the external interface of the male element and female element is covered by the cured adhesive composition and the adhesive composition covering the external interface of the male element and female element limits corrosion of at least a portion of the male element, the female element, or both.

### GOVERNMENT SUPPORT CLAUSE

This invention was made with government support under Subcontract No. 4000153415 to Prime Contract No. DE-AC05-0R22725 awarded by the Department of Energy (DOE). The government has certain rights in the invention.

### BACKGROUND

Conventionally, in the heating, ventilation and air conditioning (HVAC) heat exchanger industry, pipes are joined together using a process called brazing. Brazing is a pipe bonding process where metal objects are joined together by melting and flowing a filler metal into the joint. In most instances, the joints being joined are made of similar metals (i.e., copper/copper) therefore galvanic corrosion between joints is not a concern. However, in certain specialty applications, the two metal surfaces being joined are made up of dissimilar metals, and galvanic corrosion can become an issue leading to premature joint failure or compromise. Conventionally, these dissimilar metal joints are brazed together using the typical process, followed by a postprocessing step where a section of heat-shrink tubing is placed over the brazed joint and heated (to induce shrinkage) to form a watertight seal over the joint. The heat shrink tubing serves to eliminate or diminish galvanic corrosion between the two metals due to water bridging the gap between metal surfaces.

One major drawback of the current process above is that it involves multiple steps. The joint is first brazed, and then in a second step the heat shrink tubing is applied. This process is time consuming and requires individual heating of each individual joint in a complex assembly to induce shrinkage of the tubing.

Accordingly, what is needed in the industry is an easier, less time-consuming process or method of bonding two dissimilar metals together that will both provide a strong joint and eliminate or minimize galvanic corrosion at the interface of the two metals.

### SUMMARY OF THE DISCLOSURE

The present disclosure provides a method of bonding two dissimilar metals together as well as articles formed thereby. The methods and articles formed thereby advantageously provide bonded articles that are bonded using an efficient and less time consuming method than previously utilized methods but can still simultaneously reduce or prevent galvanic corrosion when exposed to aqueous environments.

In one embodiment, methods of forming bonds are disclosed, such methods comprise applying an adhesive composition to at least the male element, the male element comprising a first metal; inserting at least a portion of the male element into the female element thereby forming an external interface between the male element and the female element, the female element comprising a second metal; and curing the adhesive composition to form an adhesive bond between the male element and the female element, wherein the first metal and the second metal are not the same, and the adhesive bond limits corrosion of at least a portion of the male element or the female element, and wherein the external interface of the male element and female element is covered by the cured adhesive composition.

Also disclosed are bonded articles, the bonded articles comprising: a male element; a female element; and an adhesive bond, wherein the male element is inserted into the female element, the male element and the female element comprise two different metals respectively, the adhesive bond is positioned between the male element and the female element, and the adhesive bond limits the amount of galvanic corrosion between the male element and the female element in comparison to the male element and the female element without the adhesive bond.

Also disclosed are methods of decreasing galvanic corrosion between two dissimilar metals, the methods comprising: applying an adhesive composition to at least a male element, the male element comprising a first metal; inserting at least a portion of the male element into a female element, thereby forming an interface between the male element and the female element, the female element comprising a second metal; and curing the adhesive composition to form an adhesive bond between the male element and the female element, wherein the first metal and the second metal are not the same, and the adhesive bond decreases galvanic corrosion of the male element, the female element, or both.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other claims are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.) and any sub-ranges (e.g., 1 to 5 includes 1 to 4, 1 to 3, 2 to 4, etc.).

As used herein, the term “room temperature” refers to a temperature of 20° C. to 25° C.

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The phrase “adhesive composition” refers to a composition, which on its own or in combination with another composition may, once cured, adhere two materials together, thereby forming an adhesive bond. In some instances, an adhesive composition in combination with another adhesive composition can form an adhesive bond once the adhesive compositions are cured. In some such instances, the adhesive compositions may be the same, some such adhesive compositions can be referred to as one part or one component (1K) adhesives. Illustrative 1K adhesives include, for example 1K epoxy adhesives, 1K acrylate adhesives, 1K urethane adhesives, as well as hybrids of the above chemistries. In some instances, two adhesive compositions components may be different, some such adhesive compositions can be referred to as two part or two component (2K) adhesives. 2K adhesives are generally made up of a Resin (Part A) and a Hardener (Part B). Generally, these materials are mixed prior to application of the materials onto the substrate surface. After the two parts are mixed, curing can occur, not necessarily immediately and not necessarily without an outside influence (e.g., heat, energy, etc.). Illustrative 2K adhesives include, for example, 2K epoxy adhesives, 2K acrylate adhesives, and 2K urethane adhesives as well as hybrids of the above chemistries. It should be noted that there is no additional inference to be made from referring to a composition as first or second, it is merely for the sake of convenience and clarity.

The phrase “adhesive bond” is a result of curing the first and/or first and second precursor adhesive compositions. The adhesive bond in this case serves to adhere the joining region of the first article to the joining region of the second article.

The phrase “female element” refers to an article that has a hollow generally cylindrical body with an internal diameter. A female element can be formed by using a pipe with a larger starting diameter than the “male element” or be accomplished by flaring/widening the end of a smaller diameter pipe (i flaring a “male element” so that it becomes a larger diameter member that can serve as a “female element”).

The phrase “male element” refers to an article that has a hollow generally cylindrical body that fits within the female element and has an external diameter slightly less than the internal diameter of the female element. Generally, the difference between the outer diameter of the male element and the inner diameter of the female element is on the order of 2-50 thousandths of an inch, most typically 5-20 thousandths of an inch.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF FIGURES

FIGS. 1A-1E are schematic illustrations of illustrative articles that may be useful or made using disclosed methods.

### DETAILED DESCRIPTION OF ILLUSTRATIVE EMBODIMENTS

The present disclosure provides methods of joining two articles together.

The present disclosure involves a process where the equivalent of both the brazing and heat shrink tubing application steps are combined into a single operation. In this invention, the adhesive is applied onto the outside of the male pipe in a way that, when inserted into the female joint, it creates a sealed joint that irreversibly joins the two pipes together upon curing. At the same time, the adhesive is further applied onto the surface of at least the male end of the pipe along the length in order to act as a coating that inhibits galvanic corrosion. By following this process, the need for a heat shrink tubing to be applied to the system is eliminated. Optionally, a portion of the external surface of the female element can also be coated using the adhesive to act as a barrier to eliminate the heat shrink tubing. Also optionally, the female end can be exclusively coated using the adhesive to act as a barrier to eliminate the heat shrink coating, with the male end of the pipe only having enough adhesive applied to its surface to ensure formation of a sealed joint upon insertion into the female joint and curing.

The methods disclosed herein are methods of forming a bond. The methods include a step of applying an adhesive composition to some portion of the end of at least the male element; inserting the male element into the female element; and curing the adhesive composition. At least some portion of an external surface of the male element, the female element, or both can also have adhesive composition applied thereto. At least the external interface where both the male element and the female element are exposed to the atmosphere, referred to herein as an external interface, is coated with adhesive. The adhesive on the external interface does not necessarily assist in adhering the two articles together but does prevent or at least decrease the amount of galvanic corrosion that can happen at the interface of the two dissimilar metals.

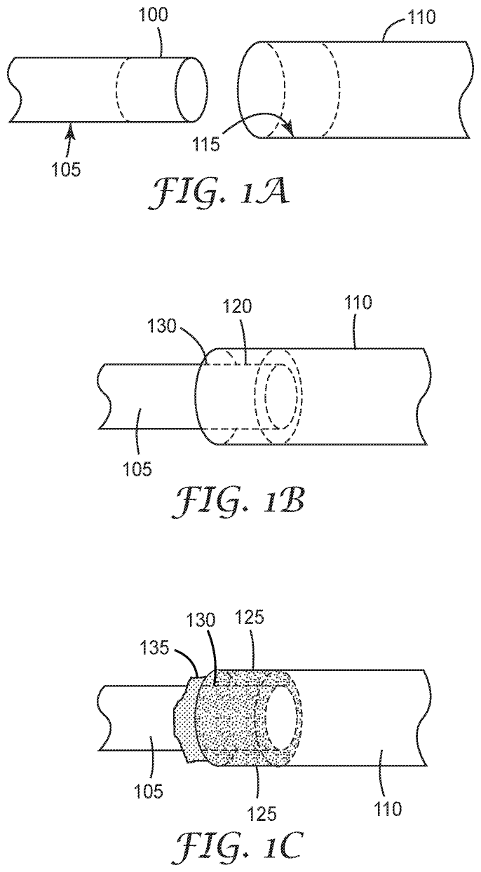

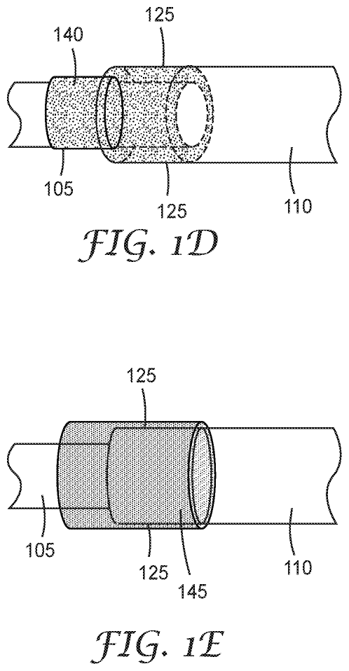

FIG. 1A illustrates a first article 105. The first article 105 is generally configured as a male element and is made of or includes a first metal. The first article 105 includes a joining region 100. At least the joining region 100 of the first article 105 is made of a first metal. FIG. 1A also shows a second article 110. The second article 110 is generally configured as a female element and is made of or includes a second metal. The second article 110 also includes a joining region 115. At least the joining region 115 of the second article 110 is made of a second metal. The first metal and the second metal are selected from copper (Cu), aluminum (Al), stainless steel, or brass. In some embodiments, the first metal and the second metal are copper (Cu) and aluminum (Al) respectively.

In some methods, initial steps can include applying an adhesive composition to at least the joining region of the first article or the male element. In some such embodiments, the adhesive composition can be a 2K epoxy, 2K acrylic, or 2K urethane. In some such embodiments, the adhesive composition can be a 1-part (1K) epoxy adhesives, 1K acrylic adhesives, or 1K urethane.

Generally, adhesive compositions that can be used herein are structural adhesives. Structural adhesives may be divided into two broad categories: one-part adhesives and two-part adhesives. With a one-part adhesive, a single composition comprises all the materials necessary to obtain a final cured adhesive. In the case of thermally cured epoxies, these materials are typically applied to the substrates to be bonded and exposed to elevated temperatures (e.g., temperatures greater than 50° C.) to cure the adhesive.

In contrast, two-part adhesives comprise two components. The first component, typically referred to as the “base resin component,” comprises the curable resin, e.g., a curable epoxy resin. The second component, typically referred to as the “accelerator component,” comprises the curing agent(s) and catalysts. Various other additives may be included in one or both components.

Epoxy resins function as a cross-linkable component in the structural adhesive. The term “epoxy resin” is used herein to mean any of monomeric, dimeric, oligomeric or polymeric epoxy materials containing at least one epoxy functional group per molecule. Such compounds include monomeric epoxy compounds and epoxides of the polymeric type and can be aliphatic, cycloaliphatic, aromatic or heterocyclic. Monomeric and oligomeric epoxy compounds have at least one and preferably one to four polymerizable epoxy groups per molecule. In polymeric type epoxides or epoxy resins, there may be many pendent epoxy groups (for example, a glycidyl methacrylate polymer could have several thousand pendent epoxy groups per average molecular weight).

The molecular weight of the epoxy resins may vary from low molecular weight monomeric or oligomeric epoxy resins with a molecular weight, for example, from about 100 g/mol to epoxy resins with a molecular weight of about 50,000 g/mol or more and may vary greatly in the nature of their backbone and substituent groups. For example, the backbone may be of any type, and substituent groups thereon can be any group not having a nucleophilic group or electrophilic group (such as an active hydrogen atom) which is reactive with an oxirane ring. Illustrative of permissible substituent groups are halogens, ester groups, ethers, sulfonate groups, siloxane groups, nitro groups, amide groups, nitrile groups, phosphate groups, etc. Mixtures of epoxy resins can also be used. In some embodiments, a structural adhesive comprises a mixture of two or more epoxy resins in order to modify and adapt the mechanical properties of the cross-linked structural adhesive with respect to specific requirements.

Types of epoxy resins that can be used include, for example, the reaction product of bisphenol A and epichlorohydrin, the reaction product of phenol and formaldehyde (novolac resin) and epichlorohydrin, peracid epoxies, glycidyl esters, glycidyl ethers, the reaction product of epichlorohydrin and p-amino phenol, the reaction product of epichlorohydrin and glyoxal tetraphenol and the like.

Epoxides that are particularly useful in the present invention are of the glycidyl ether type. Suitable glycidyl ether epoxides may include those in general formula (I):

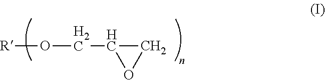

wherein R′ is alkyl, alkyl ether, or aryl; n is at least 1 and, in particular, in the range from 1 to 4. Suitable glycidyl ether epoxides of formula (I) include glycidyl ethers of Bisphenol A and F, aliphatic diols or cycloaliphatic diols. In some embodiments the glycidyl ether epoxides of formula (I) have a molecular weight in the range of from about 170 g/mol to about 10,000 g/mol. In other embodiments, the glycidyl ether epoxides of formula (I) have a molecular weight in the range of from about 200 g/mol to about 3,000 g/mol.

Useful glycidyl ether epoxides of formula (I) include linear polymeric epoxides having terminal epoxy groups (for example, a diglycidyl ether of polyoxyalkylene glycol) and aromatic glycidyl ethers (for example, those prepared by reacting a dihydric phenol with an excess of epichlorohydrin). Examples of useful dihydric phenols include resorcinol, catechol, hydroquinone, and the polynuclear phenols including p,p′-dihydroxydibenzyl, p,p′-dihydroxyphenylsulfone, p,p′-dihydroxybenzophenone, 2,2′-dihydroxyphenyl sulfone, p,p′-dihydroxybenzophenone, 2,2-dihydroxy-1,1-dinaphrhylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihy droxy dipheny Icy clohexane. Suitable commercially available aromatic and aliphatic epoxides include diglycidylether of bisphenol A (for example, available under the tradename EPON 828, EPON 872, EPON 1001, EPON 1310 and EPONEX 1510 from Hexion Specialty Chemicals GmbH in Rosbach, Germany); DER-331, DER-332, and DER-334 (available from Dow Chemical Co. in Midland, MI); diglycidyl ether of bisphenol F (for example, EPICLON 830 available from Dainippon Ink and Chemicals, Inc.); PEGioooDGE (available from Polysciences, Inc. in Warrington, PA); silicone resins containing diglycidyl epoxy functionality; flame retardant epoxy resins (for example, DER 580, a brominated bisphenol type epoxy resin available from Dow Chemical Co. in Midland, MI); 1,4-dimethanol cyclohexyl diglycidyl ether; and 1,4-butanediol diglycidyl ether. Other epoxy resins based on bisphenols are commercially available under the tradenames D.E.N., EPALLOY and EPILOX. Additional useful resins can include, for example Erisys GA240, Araldite MY0500, and Araldite MY720 (all commercially available from Huntsman International, LLC Texas). In some embodiments, the structural adhesives of the present invention may comprise from about 20% to about 90% by weight epoxy resin. In other embodiments, the structural adhesives may comprise from about 40% to about 70% by weight epoxy resin. In yet other embodiments, the structural adhesives may comprise from about 40% to about 60% by weight epoxy resin.

FIG. 1B shows the first article 105 and the second article 110 after the first article has been inserted into the second article. In the particular embodiment depicted in FIG. 1B, the first article 105 can be considered the male part and the second article 110 can be considered the female part.

After, the adhesive compositions is applied to the first article, the first and second articles are then put together so the joining regions overlap at the adhesive region 120. The adhesive region 120 extends beyond the external interface 130. The external interface is where the female element ends on the male element. Once cured, the adhesive composition that forms the adhesive region 120 forms an adhesive bond. Curing the adhesive composition(s) can be accomplished by applying heat to the adhesive compositions, via the application of certain wavelengths of energy (i.e., UV triggering of the adhesive), or IR irradiation of the pipe to heat the substrate, or induction curing. The particular method of curing chosen can be based at least in part on the particular adhesive composition(s) being utilized or the substrates being used.

As seen in FIG. 1C, the adhesive bond attaches the first article 105 to the second article 110. The adhesive bond 125 attaches the joining region 100 of the first article 105 to the joining region 115 of the second article 110. The adhesive 135, or the adhesive bond 125 contacts the external interface 130. It can also be said that the adhesive 135, the adhesive bond 125, or the combination thereof covers the external interface 130. The adhesive 135 covering the external interface 130 can decrease or even prevent galvanic corrosion at the external interface.

As seen in FIG. 1D, the adhesive bond 125 can extend beyond the external interface as well, for example, the adhesive can extend beyond the external interface onto a portion of the first article 105, the male element in the case of FIG. 1D. FIG. 1E illustrates an example where the adhesive bond 125 not only extends onto the first article 105 but also onto the second article 110, or the female element.

Articles that are joined via disclosed methods may have advantageous properties in comparison to articles joined via other methods. In some embodiments, articles can have advantageous corrosion resistant properties, mechanical strength, leak resistance, fatigue resistance, or combinations thereof.

Articles that are joined herein may have pipe configurations, or irregular configurations (e.g., oval, square, etc.)

### Exemplary Aspects

Aspect 1 is a method of bonding a male element and a female element, the method comprising: applying an adhesive composition to at least the male element, the male element comprising a first metal; inserting at least a portion of the male element into the female element thereby forming an external interface between the male element and the female element, the female element comprising a second metal; and curing the adhesive composition to form an adhesive bond between the male element and the female element, wherein the first metal and the second metal are not the same, wherein the external interface of the male element and female element is covered by the cured adhesive composition and the adhesive composition covering the external interface of the male element and female element limits corrosion of at least a portion of the male element, the female element, or both.

Aspect 2 is a method according to aspect 1, wherein the adhesive composition comprises a 1-part (1K) epoxy adhesive.

Aspect 3 is a method according to aspect 1, wherein the adhesive composition comprises a 2-part (2K) epoxy adhesive.

Aspect 4 is a method according to aspect 1, wherein the adhesive composition comprises acrylic adhesive, 1K urethane adhesive, 2K urethane adhesive, or combinations thereof.

Aspect 5 is a method according to any of the preceding aspects, wherein the first metal and the second metal are selected from copper (Cu), aluminum (Al), brass, or stainless steel.

Aspect 6 is a method according to any of the preceding aspects, wherein the cured adhesive composition covers a portion of the external surface of the male element.

Aspect 7 is a method according to any of the preceding aspects, wherein the cured adhesive composition covers a portion of the external surface of the female element.

Aspect 8 is a method according to any of the preceding aspects, wherein the cured adhesive composition covers both a portion of the external surface of the male element and a portion of the external surface of the female element.

Aspect 9 is a method according to any of the preceding aspects, wherein the step of curing occurs at temperatures above room temperature.

Aspect 10 is a method according to any of aspects 1 to 9, wherein the step of curing occurs at room temperature.

Aspect 11 is a bonded article, the bonded article comprising: a male element; a female element; and an adhesive bond, wherein the male element is inserted into the female element thereby forming an external interface between the male element and the female element, the male element and the female element comprise two different metals respectively, the adhesive bond is positioned between the external surface of the male element and the internal surface of the female element, and the adhesive composition at the external interface limits the amount of galvanic corrosion between the male element and the female element in comparison to the male element and the female element without the adhesive composition at the external interface.

Aspect 12 is a bonded article according to aspect 11, wherein the adhesive bond comprises a 1-part (1K) epoxy adhesive.

Aspect 13 is a bonded article according to aspect 11, wherein the adhesive bond comprises a 2-part (2K) epoxy adhesive.

Aspect 14 is a bonded article according to aspect 11, wherein the adhesive composition comprises acrylic adhesive, 1K urethane adhesive, 2K urethane adhesive, or combinations thereof.

Aspect 15 is a bonded article according to any of aspects 11 to 14, wherein the first metal and the second metal are selected from copper (Cu), aluminum (Al) brass, or stainless steel.

Aspect 16 is a bonded article according to any of aspects 11 to 15 further comprising adhesive composition covering a portion of the external surface of the male element.

Aspect 17 is a bonded article according to any of aspects 11 to 16 further comprising adhesive composition covering a portion of the external surface of the female element.

Aspect 18 is a bonded article according to any of aspects 11 to 17 further comprising adhesive composition covering both a portion of the external surface of the male element and a portion of the external surface of the female element.

Aspect 19 is a method of decreasing galvanic corrosion between two dissimilar metals, the method comprising: applying an adhesive composition to at least a male element, the male element comprising a first metal; inserting at least a portion of the male element into a female element thereby forming an external interface between the male element and the female element, the female element comprising a second metal; and curing the adhesive composition to form an adhesive bond between the male element and the female element, wherein the first metal and the second metal are not the same, and the adhesive composition covering the external interface of the male element and female element limits corrosion of at least a portion of the male element, the female element, or both.

Aspect 20 is a method according to aspect 19, wherein the adhesive composition comprises a 1-part (1K) epoxy adhesive.

Aspect 21 is a method according to aspect 19, wherein the adhesive composition comprises a 2-part (2K) epoxy adhesive.

Aspect 22 is a method according to aspect 19, wherein the adhesive composition comprises acrylic adhesive, 1K urethane adhesive, 2K urethane adhesive, or combinations thereof.

Aspect 23 is a method according to any of aspects 19 to 22, wherein the first metal and the second metal are selected from copper (Cu), aluminum (Al), brass, or stainless steel.

Aspect 24 is a method according to any of aspects 19 to 23, wherein the cured adhesive composition covers a portion of the external surface of the male element.

Aspect 25 is a method according to any of aspects 19 to 23, wherein the cured adhesive composition covers a portion of the external surface of the female element.

Aspect 26 is a method according to any of aspects 19 to 25, wherein the cured adhesive composition covers both a portion of the external surface of the male element and a portion of the external surface of the female element.

Aspect 27 is a method according to any of aspects 19 to 26, wherein the step of curing occurs at temperatures above room temperature.

Aspect 28 is a method according to any of aspects 19 to 26, wherein the step of curing occurs at room temperature.

### EXAMPLES

These examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding.

### Materials

| Material | Description |
|---|---|
| Amicure | Dicyandiamide curative, obtained under the trade |
| CG1200 | designation “AMICURE CG1200”, from Evonik, |
| | Essen, Germany |
| OFS-6040 | Glycidylpropyl trimethoxysilane adhesion |
| | promoter, obtained under the trade designation |
| | “XIAMETER OFS-6040 SILANE”, from Dow |
| | Chemical, Midland, MI |
| Carbon black | 20% carbon black dispersed in Bis A epoxy, |
| paste | obtained from Clariant AG, Muttenz, Switzerland |
| EPON 828 | Difunctional Bis A epoxy, obtained under the |
| | trade designation “EPON 828”, from Hexion |
| | Inc, Columbus, OH |
| DSPD | N-N′-Disalicyidiene-1,2-propanediamine |
| | (CAS #94-91-7), obtained from 3M Company, |
| | St. Paul, MN |
| SL300 | Hollow ceramic spheres having mean particle |
| | size of 100 micrometers, obtained under the |
| | trade designation “E-SPHERES SL300”, from |
| | Envirospheres Pty. Ltd., Lindfield NSW |
| | Australia |
| TS-720 | Hydrophobic amorphous silica, obtained under |
| | the trade designation “CAB-O-SIL TS-720”, |
| | from Cabot Corp. Billerica, MA |
| Toyal 201 | Aluminum Powder with mean diameter of 23 |
| | microns, obtained under the trade designation |
| | “TOYAL 201”, from Toyal America, Lockport, |
| | IL |
| MX-257 | Core Shell dispersed in difunctional bis A epoxy, |
| | obtained under the trade designation “KANE- |
| | ACE MX-257”, from Kaneka Corporation, |
| | Tokyo, Japan |
| MY0500 | Multifunctional epoxy, obtained under the trade |
| | designation “ARALDITE MY 0500”, from |
| | Huntsman Corporation, The Woodlands, TX |
| PW80 | Mineral Filler, obtained under the trade |
| | designation “MICAFORT PW80”, from LKAB |
| | minerals, Lulea, Sweden |
| U52M | Urea cure accelerator, obtained under the trade |
| | designation “OMNICURE U-52M”, from |
| | Huntsman Corporation, The Woodlands, TX |
| D-410 | Rheology modifier, obtained under the trade |
| | designation “RHEOBYK D-410”, from BYK- |
| | Chemie GmbH, Wesel, Germany |
| DP-420 | 2K epoxy structural adhesive, obtained under the |
| | trade designation “DP-420 Black”, from 3M |
| | corporation, St. Paul, MN |

### Sample Preparation

For Adhesive 1, all materials except for the catalyst and accelerant (Amicure CG1200 and U52M, respectively) were combined in MAX 100 cups (available from Flacktek Inc, Landrum, SC) and mixed fully on a DAC 600 FVZ speed mixer (Flacktek, Inc) for 2 minutes @1800 rpm. After cooling, the catalyst and accelerant were added and mixed in the DAC speed mixer for 2 minutes @ 1800 RPM. Relative amounts of materials used can be found in Table 1 below. After mixing, the adhesive was stored at −20° C. in a freezer until needed for evaluation.

TABLE 1

| Raw Material | Amount |
|---|---|
| Amicure CG1200 | 2.8 |
| OFS-6040 | 0.4 |
| Carbon black paste | 1.6 |
| EPON 828 | 4.8 |
| DSPD | 13.9 |
| SL300 | 0.2 |
| TS-720 | 1.4 |
| Toyal 201 | 25.1 |
| MX-257 | 21.5 |
| MY0500 | 22.6 |
| PW80 | 4.5 |
| U52M | 0.8 |
| D-410 | 0.8 |

### Testing Methods

Samples were tested following ASTM B117. In particular, a 5% salt solution was used as the testing medium. Prior to putting the samples into the chamber, both ends of the bonded pipes were sealed off using silicone rubber stoppers to eliminate ingress of the salt spray solution into the interior of the pipes. The rubber stoppers were taped (using TEFLON tape) into position to keep them from coming undone during handling.

### Air Leak Test

Samples were tested for air leaks after aging samples for 1,000 hours in salt-spray conditions. Sample evaluation was completed by sealing one end of the bonded pipes by submerging it in a vial cap containing uncured DP420 and allowing the material to cure and seal the end of the pipe. The unsealed end of the pipe was then attached to a rubber hose connected to house air (90 psi pressure when fully open). The sample was submerged under water in a 5-gallon bucket and the pressurized using house air to 90 psi internal pressure. The sample was then visually checked for bubbling, with any bubbles being noted after a pressurization period of 1 minute being considered a “failure.”

### Sample Preparation and Assembly

Seven sets of adhesively bonded samples were prepared for evaluation in a salt spray chamber. Both the copper and aluminum pipes were obtained from McMaster Carr (Elmhurst, IL) as straight, ⅜ inch diameter sections of pipe. Copper pipe substrates (assembly part A, except for example set 6, which used aluminum) were prepared by cutting copper pipe into 3 inch sections and flaring one end of the pipe using a pipe flaring tool. The other section (assembly part B) to be joined was made up of either a 3 inch section of aluminum pipe (sample sets 1, 2, 4, 5, 7, and 8) or a 3 inch section of copper pipe (sample set 3 and 6). The control set was fabricated by brazing together a straight section of aluminum pipe to a flared section of copper pipe.

After sample substrates were cut and, optionally, flared, they were cleaned using heptane to remove any residual oils on their surface. After cleaning, adhesive 1 (a 1K epoxy) or DP420 was used to bond the pipes as well as applied to the surface of the of the specified sections (see table 2 below). The adhesive was coated onto the surface of pipes using a foam dauber (3M Urethane Primer Dauber, part number 08688, available from 3M). After coating, the samples were placed into a metal test-tube rack in vertical position with the “female” pipe as the lower section and placed into an oven to cure for 30 minutes at 150° C. for parts bonded with Adhesive 1. For parts bonded with DP420, samples were cured in the same assembly at room temperature for 48 hours prior to exposure to salt spray testing. After removal from the oven, the samples were inspected for physical defects. In total, either two or four samples were made for each set of the conditions and placed into a salt spray chamber for evaluation after 1,000 hours of aging.

TABLE 2

| | Part A | Part B | | | Air Leak test |
|---|---|---|---|---|---|
| Sample | (flared) | (straight) | Bonding | Corrosion | (90 psi) @ |
| number | coated? | coated? | method | Evaluation | 1,000 hrs |
| 1 (Cu/Al) | N | N | Adhesive 1 | Severe | 1/2 passed |
| 2 (Cu/Al) | N | Y | Adhesive 1 | Minimal | 3/4 passed |
| 3 (Cu/Cu) | Y | Y | Adhesive 1 | Minimal | 2/2 passed |
| 4 (Cu/Al) | Y | Y | Adhesive 1 | Minimal | 2/2 passed |
| 5 (Cu/Al) | Y | N | Adhesive 1 | Minimal | 2/2 passed |
| 6 (Al/Cu) | N | Y | Adhesive 1 | Minimal | 4/4 passed |
| 7 (Cu/Al) | N | N | DP420 | Severe | 0/4 passed |
| 8 (Cu/Al) | Y | Y | DP420 | Minimal | 4/4 passed |

| | | | | |
|---|---|---|---|---|
| Control | Wrapped in Tape to mimic | Braze | Minimal | 2/2 passed |
| | Heat Shrink Tubing | | | |

### Results

Test specimens were taken from the chamber for each sample type 1,000 hours of exposure and evaluated for corrosion. Evaluation was done through visual inspection to look for undercutting of the bonds, abnormal corrosion, or coating degradation. Results can be found in Table 2. For the sake of this evaluation, minimal corrosion was defined as: light spotting on the aluminum and/or copper, exposed metal surfaces largely still smooth to the touch; whereas severe corrosion was defined as: surface of the exposed aluminum and/or copper is pitted and rough; much of the aluminum is corroded away and occasional holes in the pipe may be present. In all cases, the adhesive coating on the surface of the pipes did not show undercutting of the coated bondline or delamination of the coating from the pipe surface.

After visual inspection of the salt-spray tested samples, further evaluation of the samples was done by doing an air leak test. Results of this evaluation can be found in Table 2. In general, the results correlated well with the corrosion evaluation; where severely corroded samples tended to show air leaks upon pressurization, while minimally corroded samples generally held air pressure upon testing.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A method of bonding a male element and a female element, the method comprising:
applying an adhesive composition to at least the male element, the male element comprising a first metal;
inserting at least a portion of the male element into the female element thereby forming an external interface between the male element and the female element, the female element comprising a second metal; and
curing the adhesive composition to form an adhesive bond between the male element and the female element,
wherein the first metal and the second metal are not the same, wherein the external interface of the male element and female element is covered by the cured adhesive composition and the adhesive composition covering the external interface of the male element and female element limits corrosion of at least a portion of the male element, the female element, or both.

2. The method according to claim 1, wherein the adhesive composition comprises a 1-part (1K) epoxy adhesive.

3. The method according to claim 1, wherein the adhesive composition comprises a 2-part (2K) epoxy adhesive.

4. The method according to claim 1, wherein the adhesive composition comprises acrylic adhesive, 1K urethane adhesive, 2K urethane adhesive, or combinations thereof.

5. The method according to claim 1, wherein the first metal and the second metal are selected from copper (Cu), aluminum (Al), brass, stainless steel.

6. The method according to claim 1, wherein the cured adhesive composition covers a portion of the external surface of the male element.

7. The method according to claim 1, wherein the cured adhesive composition covers a portion of the external surface of the female element.

8. The method according to claim 1, wherein the cured adhesive composition covers both a portion of the external surface of the male element and a portion of the external surface of the female element.

9. The method according to claim 1, wherein the step of curing occurs at temperatures above room temperature.

10. The method according to claim 1, wherein the step of curing occurs at room temperature.

11. A bonded article, the bonded article comprising:
a male element;
a female element; and
an adhesive bond,
wherein the male element is inserted into the female element thereby forming an external interface between the male element and the female element, the male element and the female element comprise two different metals respectively, the adhesive bond is positioned between the external surface of the male element and the internal surface of the female element, and the adhesive composition at the external interface limits the amount of galvanic corrosion between the male element and the female element in comparison to the male element and the female element without the adhesive composition at the external interface.

12. The bonded article according to claim 11, wherein the adhesive bond comprises a 1 part (1K) epoxy adhesive.

13. The bonded article according to claim 11, wherein the adhesive bond comprises a 2 part (2K) epoxy adhesive.

14. The bonded article according to claim 11, wherein the adhesive composition comprises acrylic adhesive, 1K urethane adhesive, 2K urethane adhesive, or combinations thereof.

15. The bonded article according to claim 11, wherein the first metal and the second metal are selected from copper (Cu), aluminum (Al) brass, or stainless steel.

16. The bonded article according to claim 11 further comprising adhesive composition covering a portion of the external surface of the male element.

17. The bonded article according to claim 11 further comprising adhesive composition covering a portion of the external surface of the female element.

18. The bonded article according to claim 11 further comprising adhesive composition covering both a portion of the external surface of the male element and a portion of the external surface of the female element.

19. A method of decreasing galvanic corrosion between two dissimilar metals, the method comprising:
applying an adhesive composition to at least a male element, the male element comprising a first metal;
inserting at least a portion of the male element into a female element thereby forming an external interface between the male element and the female element, the female element comprising a second metal; and
curing the adhesive composition to form an adhesive bond between the male element and the female element, wherein the first metal and the second metal are not the same, and the adhesive composition covering the external interface of the male element and female element limits corrosion of at least a portion of the male element, the female element, or both.
